(19) United States
(12) Patent Application Publication
(10) Pub. No.: US 2003/0120515 A1
(43) Pub. Date: Jun. 26, 2003

(54) Method and system for managing health

(76) Inventor: Jacob Geller, Montclair, NJ (US)

Correspondence Address: RATNERPRESTIA, P O BOX 980, VALLEY FORGE, PA, 19482-0980, US

(21) Appl. No.: 10/287,957

(22) Filed: Nov. 5, 2002

Related U.S. Application Data
(60) Provisional application No. 60/338,746, filed on Nov. 5, 2001.

(51) Int. Cl. G06F 17/60

(52) U.S. Cl. 705/2; 705/4

(57) ABSTRACT

A healthcare management system is configured for personal health care management. The system includes a plurality of health management modules. Each of the modules is configured to receive and store information relating to personal healthcare, and at least one of the modules being configured to store health transactions of an individual or group of individuals. The system also includes a graphical interface for providing access to each of the modules. A method of managing health care is also provided.

### CROSS REFERENCE TO RELATED APPLICATIONS

Benefit is claimed to U.S. provisional application serial No. 60/338,746, filed Nov. 5, 2001, incorporated herein by reference.

### FIELD OF THE INVENTION

This invention relates to health management. More particularly, this invention relates to a method and system for managing personal health.

### BACKGROUND OF THE INVENTION

As the population of the United States ages, there comes illness and the inevitable demand for more utilization of healthcare. That is, there is an increasing variety of treatments, and more of these treatments being performed. These factors tend to increase the complexity of potential medical treatment programs, as well as the possibility that any given physician may not be fully aware of all of the information available regarding a particular disease or condition.

At the same time, healthcare consumers have greater access than ever before to health information, via the Internet, with the result being that sophisticated consumers are increasingly desirous of taking a stronger role in directing and evaluating their own medical care, and that of their family members. However, consumers are confused about some aspects of healthcare and the healthcare system, and mistrust the quality of care received under managed care insurance programs.

A need therefore exists for methods and systems capable of helping consumers manage the various aspects of their own healthcare, and that of their family members, especially methods and systems that can be used in the privacy of their own homes.

### SUMMARY OF THE INVENTION

In one exemplary embodiment, the invention provides a health management system configured for personal health management. The system comprises a software application including a plurality of health management modules, each of the health management modules being configured to store information relating to personal health. One or more of the health management modules is a transaction module configured to receive and store health transactions of an individual or a group of individuals. The system also comprises an interface configured to provide access to one or more of the health management modules.

In another exemplary embodiment, the invention provides a method for managing personal health. The method comprises the steps of storing health transactions in a transaction module of a software application, wherein the transaction module is configured to receive and store the health transactions of an individual or a group of individuals; and accessing the transaction module using an interface.

In still another exemplary embodiment, the invention provides a method of providing a health management system configured for personal health management. The method comprises the steps of providing a software application including a plurality of health management modules, including configuring each of the health management modules to store information relating to personal health; configuring one or more of the health management modules to be a transaction module capable of receiving and storing health transactions of an individual or a group of individuals; and configuring one or more of the health management modules to be accessible using an interface.

### BRIEF DESCRIPTION OF THE DRAWINGS

This invention will be described with reference to selected figures, of which:

FIG. 1 is a screen shot of an exemplary home page for an embodiment of a health management system according to aspects of this invention.

FIG. 2 is a screen shot of an exemplary journal page, configured to provide a health journal of family vaccinations.

FIG. 3 is a screen shot of an exemplary body mass index calculator, provided according to aspects of this invention.

FIG. 4 is a screen shot of an exemplary breast cancer risk calculator, provided according to aspects of this invention.

FIG. 5 is a screen shot of an exemplary risk assessment guide for determining one's risk of developing chronic heart disease, provided according to aspects of this invention.

FIG. 6 is a screen shot of an exemplary calculator for determining exercise calorie burn.

FIG. 7 is a screen shot of an exemplary calendar for providing a record of family chiropractor events, provided according to aspects of this invention.

FIG. 8 is a screen shot of a health risk assessment page, provided according to aspects of this invention.

FIG. 9 is a screen shot of an exemplary family history manager indicating one's medical history according to aspects of this invention.

FIG. 10 is a screen shot of a family history manager for recording preventive health history according to aspects of this invention.

FIG. 11 is a screen shot of an exemplary family history manager for recording family history according to aspects of this invention.

FIG. 12 is a screen shot of a family tree page, provided for recording a family tree according to aspects of this invention.

FIG. 13 is a screen shot of a symbolic environment for use of the system, entitled QuestLand, according to exemplary aspects of this invention.

FIG. 14 is a schematic diagram of an exemplary embodiment of a computer system with which a health management system according to this invention can be used.

FIG. 15 is a schematic diagram of an exemplary embodiment of a health management system according to aspects of this invention.

FIG. 16 is a schematic diagram of another exemplary embodiment of a health management system according to aspects of this invention.

FIG. 17 is a flow diagram of an exemplary embodiment of a method according to aspects of this invention.

FIG. 18 is a flow diagram of another exemplary embodiment of a method according to aspects of this invention.

### DETAILED DESCRIPTION OF THE INVENTION

The invention will now be described with reference to specific embodiments selected for illustration in the drawings. It will be appreciated that the spirit and scope of this invention are not limited to the embodiments selected for illustration and set forth in the text. Instead, the scope of this invention is defined separately in the appended claims.

According to preferred aspects, this invention provides a computer software system that can be utilized by the consumer segment of the international healthcare market. More specifically, exemplary aspects of this invention provide a computer-based (e.g., a CD-ROM-based or Internet-based) personal health program. For example, a computer-based system can be provided according to aspects of this invention for helping a user organize their health information including, but not limited to, cumulative reporting, weight control, assistance for insurance issues, expert information and advice, best practices and more.

According to exemplary aspects, this invention addresses the consumer's emotional and rational desire for better control and management of their own health, as well as the health of their loved ones. Consumers are attracted to products that will make them feel more in control and better organized. The tools, information and services provided according to exemplary aspects of this invention assist consumers in tracking, planning and preparing for the future. In addition, the range of services offered can preferably be accessed in the sanctity of the consumer's own home in a reliable and secure fashion.

Whether for purposes of disease management or disease prevention, exemplary aspects of this invention provide the user with data, information and tools to provide knowledge and make informed decisions. Among the benefits that may be made available to the consumer according to exemplary embodiments of this invention are maintaining health/immunization records, scheduling appointment/test/medication, reporting trends, tracking prognoses, planning for medical savings plans and insurance open enrollment options, logging self health events, and following post-op recovery progress.

According to one exemplary embodiment of this invention, a computer-based system includes two primary features. The first is the ability to enter and track personal health information as so-called “health transactions.” In other words, each health related event is considered a health transaction within the context of a preferred embodiment of this invention. Such transactions, when considered in a cumulative fashion, tend to define the health of the individual or group of individuals.

The second is reference/content that provides general information about health such as disease, drugs, testing, etc. Generally, access to such reference/content provides information to support health related decisions.

While this invention is primarily described in connection with consumer-oriented products, it is also contemplated for use in connection with Managed Care, Employer and Direct-to-Consumer (DTC) and Patient Service Center (PSC) environments.

In relation to the exemplary tracking feature, consumers can track health transactions including medical, insurance, diet, nutritional, and other events. Over the lifetime of use of this product, consumers are expected to cycle between periods of casual use and more diligent use during special periods such as a disease state. Some of the different states of the contemplated users of the system include:

Healthy

Healthy but curious

Healthy with a symptom

Short term illness

Long term illness

Family or friend in one of the above states

The following table describes exemplary features according to aspects of this invention:

| Feature | Examples |
|---|---|
| Personal Health Accounts | Medical, Lifestyle, Dental |
| Health Registers | History of Transactions |
| Health Transactions | Blood Test, X-Ray, Blood Pressure, Weight, |
| | Well-Exam, Urine Test, Culture, Pap Smear, |
| | Biopsy |
| Health Categories | Hdl, Ldl, CBC, Weight, Pressure, Protein, |
| | Creatinine |
| Health Planning | Weight Reduction Plan, Wellness Exam |
| | Schedule, Exercise Plan, Medication |
| | Schedule, Calorie Counter, Lifestyle |
| | Inventory |
| Health Calculators | Body Weight Index, Age/Cholesterol, |
| | Exercise Rates, Ratios, Calorie Counter, |
| | Wellness Survey |
| Reports & Graphs | Diagnostic Test Trends |
| Overall Health/Wellness | Reports |
| Health Reminders | Annual Exam, Physical, Blood Test, Dental |
| | Cleaning |
| Expertise/Best Practices | Insurance Product Descriptors (HMO, POS, |
| | Indemnity, Managed Choice) |
| Online Services | Diagnostic Test Reconciling |

This invention therefore provides, according to exemplary aspects thereof, a consumer personal health product which results in significant revenue and branding opportunities for the provider of the product. Exemplary aspects of this invention also address consumer needs. For example, aspects of this invention permit consumers to take more control of their personal health. Also, consumers are provided with a software tool that allows them to collect, organize and manage all or at least a significant portion of their medical records and other important healthcare information for themselves and their family. Such an exemplary software tool can be used in the privacy of one's home, from the security of one's own computer. Also, exemplary features of this invention help reduce consumer confusion about some aspects of healthcare and the healthcare system.

This invention, according to exemplary embodiments thereof, also helps improve the trust of consumers in managed care. For example, aspects of this invention provide consumers with greater access to health information (e.g., via the Internet). Also, aspects of this invention are well suited for an aging population (with age comes illness), in which there is more utilization of healthcare, more treatments, more cures, and potentially wealthier consumers.

Accordingly, exemplary features of this invention provide consumers with a software tool for the collection, organization and management of all their medical records and other important healthcare information for themselves and their family in the privacy of their own home, from the security of their own computer. The exemplary system would, for example, allow the user to track their own and their family's health and medical conditions; digitally store many types of relevant medical data such as vaccination and immunization shots, X-rays, MRIs, and other test results; to create reports required by camps or day care centers or schools about vaccination histories; to create graphs of the progress of personal conditions such as cholesterol levels, weight or blood pressure; to calculate health risks based on specific inputs; to store medical histories and treatment records of family members; to maintain calendars of medical visits; to organize insurance information; to track insurance transactions; and to compile libraries of medical information. In short, it is in an exemplary embodiment a tool designed to allow the user to organize and manage all information related to health and healthcare.

The personal health software according to aspects of this invention provides for the recordation and management of health transactions and facilitates health education. It also provides for organization of health-related information with minimal data entry. It also permits the user to access information in multiple views (e.g., individual and family views). Reports and graphs are provided to help users understand data and feel better organized. Consumers are placed in control of their information in strict privacy on their local off-line storage.

Exemplary aspects of this invention also make it possible to control and deliver key drivers in consumer healthcare, including commerce, content, connectivity, community and care. Preferred aspects can provide seamless integration with other efforts, including core testing, DTC and the Blueprint for Wellness program available from Quest Diagnostics, Inc. of San Juan Capistrano, Calif. Such aspects also allow consumers to organize and take control of their personal health, substantially effortlessly.

The tools, information and services provided according to aspects of this invention assist consumers in tracking, planning and preparing for the future. In addition, the range of services offered can be accessed in the privacy of the consumer's own home in a reliable and secure fashion with access to the web for keeping all information current and up-to-date. More specifically, client side storage can be provided for maximum privacy, and server side storage can be provided for maximum ease of use, as desired by the consumer. The exemplary system is adaptable to marry desktop, CD-ROM/DVD, web and wireless services for total access to complete and timely information with the greatest sense of privacy. Yearly or periodic updates and other information are optionally provided to the users of the system. Additional services are also optionally provided through an exemplary system according to this invention, such as testing, health assessment questionairres such as the BLUEPRINT FOR WELLNESS program, Disease Specific DVD's, membership in a Healthcare Club, etc. The system and associated health services are also optionally provided via a partnership with Internet Providers (IPs), software developers, and other service providers.

The exemplary system, according to aspects of this invention, is also “integrated” with popular consumer products application software. Prescription data is optionally provided using the exemplary system, and “real estate” on the system or the system's portal is optionally sold or otherwise provided to sellers of related healthcare products and services. The exemplary system is optionally used by Employer and Managed Care (therefore creating branding opportunities) and is optionally used by consumers through a DTC channel and a PSC's. The exemplary system can also be used as an integral part of a corporate wellness program.

Test results (from all or one or more selected testing service providers) are preferably automatically available for download to the users of an exemplary embodiment of this invention. This capability results in an increase in the use of such testing services because of the benefits of having this information and because the process eliminates significant data entry into the product. The exemplary system according to this invention also provides a strong potential for cross selling of products and services. There is probably no greater opportunity for getting a user's attention than when they are dealing with a health issue of themselves or a loved-one.

Exemplary features of this system also increase the visibility of the testing service provider and bring more awareness to the value of testing services. By integrating testing into the system, one can also enhance the testing business.

The use of the system according to this invention depends upon lifestage, health-related behaviors and attitudes toward health care. The key lifestage indicators are marital status and parenthood. The key behavioral indicators are regular visits to a doctor, regular exercise, regular monitoring of one's diet, and the creation of medical histories. The key attitudinal indicator is active management of one's health. In short, those individuals most likely to benefit most significantly from use of the system according to this invention are actively health conscious, married and have children under the age of 18. Although psychographic traits are less certain predictors of beneficial use of the system, leadership, risk taking and independence are likely factors as well.

In sum, the consumers most likely to benefit from use of the system and method according to this invention are likely to have the following characteristics:

Parent of children under the age of 18;

Between the ages of 36 and 45 or between 56 and 70;

Concerned about their health;

An active manager of their health;

Has experienced hospitalization;

Already maintains some form of medical records;

Displays leadership;

Dissatisfied with the healthcare system.

The services and tools offered as part of an exemplary personal health product according to this invention include one or more of the following features, or combinations thereof:

Personal Health Accounts

Planning/Budgeting

Calculators/Wizards

Reports and Graphs

Net Worth/Wellness

Reminders

Expertise/Best Practices

Open Exchange Standards

A brief description of each exemplary offering follows:

Accounts

According to one aspect of a personal health product according to this invention, health transactions are tracked in personal health accounts. Separate accounts may be maintained for each family member. Examples of health accounts include medical, dental, medication, life, diet, etc. A transaction is triggered by a lab test, an exam, weighing oneself, measuring one's height, taking medication, etc. Some transactions such as a blood test are optionally “split” into several categories such as Cholesterol, HDL, CBC etc. Other health categories may include weight, temperature, systolic pressure, diastolic pressure, pulse, EKG, symptoms, cholesterol, hdl, ldl, and calcium, for example.

Planning/Budgeting

In an exemplary personal health product according to aspects of this invention, “budgeting” for situations may include calorie consumption, fat consumption, weekly exercise schedules, and medication schedules, for example. Features for budgeting with financial considerations, as in saving for a treadmill or payment for a health procedure, may also be included in Planning/Budgeting.

Calculators/Wizards

In an exemplary personal health management system according to aspects of this invention, calculators are provided to determine body mass, cholesterol level, or target exercise levels, for example. In addition, health wizards optionally produce a plan for lowering one's weight, blood pressure, or cholesterol, and can be configured to generate a wellness document with recommendations.

Reports & Graphs

Through reports and graphs, consumers are provided with a better understanding of their personal healthcare information. The exemplary personal health product includes cumulative reporting and graphing of results, as well as other types of health related reports and graphs.

Net Worth/Wellness

The exemplary personal health product offers the overall “Wellness” of an individual. Individual wellness merges test results with survey data. A “snapshot” report details a variety of health indicators that describe an individual's overall health.

Reminders

Personal health reminders are optionally provided, according to exemplary aspects of this invention, for tests, medical visits, medication, etc.

History

In an exemplary personal health product, an in-depth family history including important historical information of a consumer is optionally made available.

Expertise/Best Practices

In an exemplary personal health product according to aspects of this invention, experts offer advice on disease management, disease prevention, wellness screening, insurance plans, etc.

Open Exchange Standards

The personal healthcare management system preferably provides the opportunity to exchange information by two significant standard records, HL7 and XML. Other configurations are contemplated as well.

Several exemplary features of one embodiment of a personal healthcare system according to this invention are listed here:

1. System helps consumers organize, track and manage their health records and to provide more functionality and tools.

2. The core basic application optionally runs on a stand-alone PC. All the application data will preferably be stored and retrieved from a local hard drive.

3. All data is preferably protected at all times including passwords for logging into the system and encryption, etc. for secure transmission of data.

4. The main application can optionally be downloaded from the web or can be installed from a purchased CD. Product upgrades can optionally be downloaded from a web site or installed using a CD.

5. User need not have an Internet connection in order to run the application, although Internet access is preferred for data transmission and information retrieval.

6. Application will support branding, which optionally includes placement of a logo and other branding items of a service provider such as a clinical testing laboratory.

7. Application is customized to adhere to the look and feel of the professional and consumer web site of the system's provider.

8. The exemplary system is a multi language application. It can, for example, support English, Spanish, German, Italian, French and other languages.

9. New content, articles and tools can be added to the application at any time as add-on products.

10. Application may run on many major platforms.

11. Application can be configured to download results from one or more web sites. For example, a generic interface can optionally be created to allow easy interface with one or more laboratories. Users can, as an option, manually enter data.

12. Users preferably have an option to encrypt their data. This can be accomplished, for example, by applying a password on the data file.

13. Registration of the system can be conducted.

14. A start-up wizard is preferably provided to tailor the system according to a user's intended use (i.e. for self, family, children, seniors, etc.). Users can optionally change one or more of these options using system settings.

15. Application preferably has a module to help technical support troubleshoot problems.

16. Product should preferably offer strong backup capabilities.

17. Disease specific CD-ROM/DVDs are provided, which transform the system into an “expert” on a particular disease. This optionally includes, for example, additional disease specific calculators, wizards, calendar updates, content, etc. Such disease specific information is optionally sold individually or can be provided for free to subscribers of related services.

18. Partnering with major hospitals and universities can be supported by the system as a source for disease specific information or CD's.

19. The system can optionally be coordinated with one or more publisher.

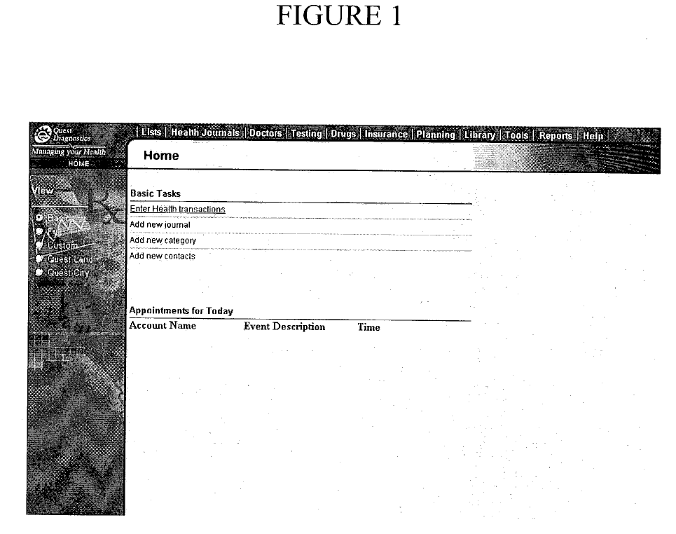

Exemplary screen shots illustrating aspects of an embodiment of this invention are provided in FIGS. 1-13. It will be appreciated that these screen shots are provided for illustrative purposes only and to show examples of aspects of this invention.

Referring to FIG. 1, a screen shot of a “Home” page is illustrated. In that screen shot, a series of basic tasks are provided, including the option to enter health transactions, add a new journal, add a new category, or add new contacts. Also shown on the Home page are the appointments for that particular day, including information regarding the account name, event description, and time. The Home page also provides options for the view provided to the user. Although the Basic view has been selected in FIG. 1, the user can optionally select a full view, a custom view, a view of “QuestLand”, and/or a view of “QuestCity”.

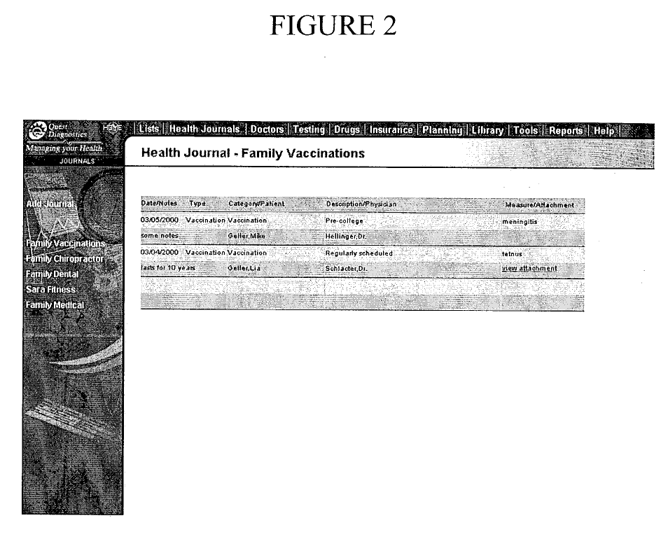

FIG. 2 illustrates a screen shot of a page entitled “Health Journal-Family Vaccinations.” This is one example of several exemplary journals provided in the menu on the left-hand side of this screen shot. This page permits the user to enter dates, types, categories, descriptions, and comments regarding each vaccination given to a family member.

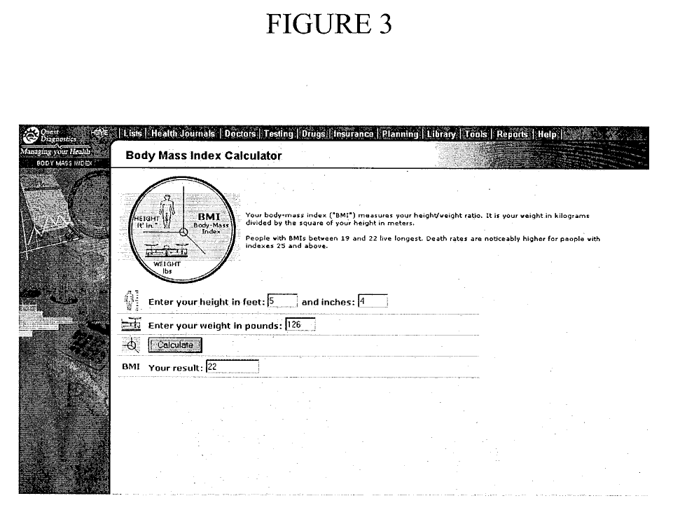

FIG. 3 provides a calculator wizard entitled “Body Mass Index Calculator.” This screen shot illustrates one example of a calculator wizard. In this example, the user's body-mass index measures one's height/weight ratio.

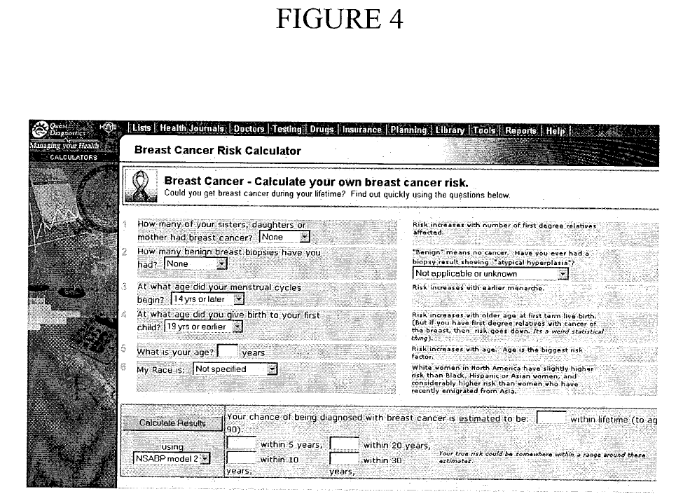

Referring now to FIG. 4, a wizard is provided for calculating one's risk of breast cancer (i.e., a “Breast Cancer Risk Calculator”). This exemplary calculator permits an individual to estimate their risk of acquiring breast cancer.

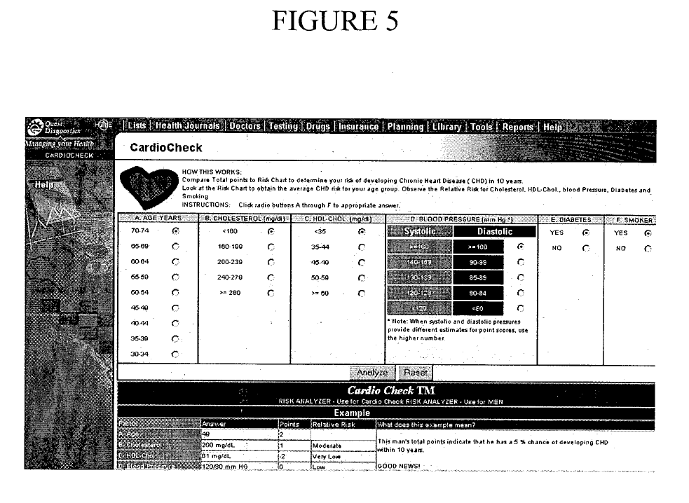

In FIG. 5, a screen shot of a “CardioCheck” calculator is provided. This calculator permits the user to determine his or her risk of developing chronic heart disease in a pre-determined period of time (e.g., ten years). The screen permits the user to enter information, and the calculator provides a risk analysis.

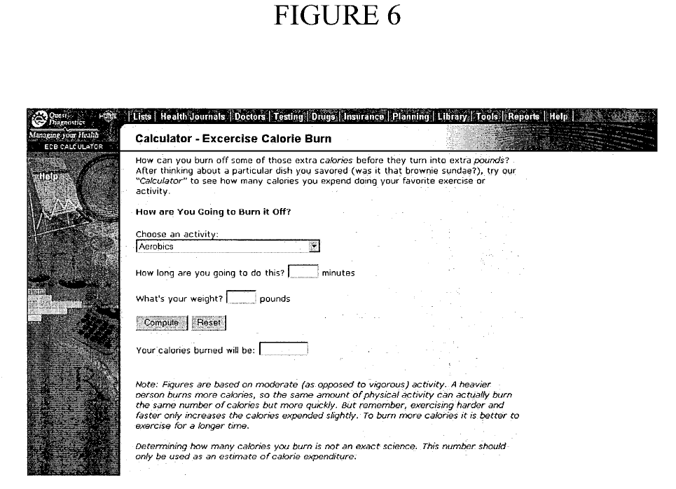

FIG. 6 shows a screen shot of a calculator for calorie consumption in an “Exercise Calorie Burn” wizard. The user can select an activity, a duration, input his or her weight, and compute how many calories will be burned.

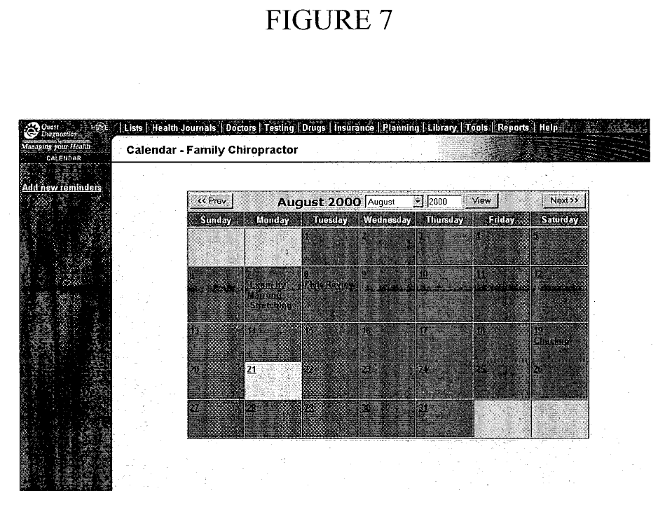

FIG. 7 provides a screen shot of a calendar dedicated to a family chiropractor. The calendar permits one to enter information and reminders regarding events relating to chiropractor visits, therapies, and other related activities.

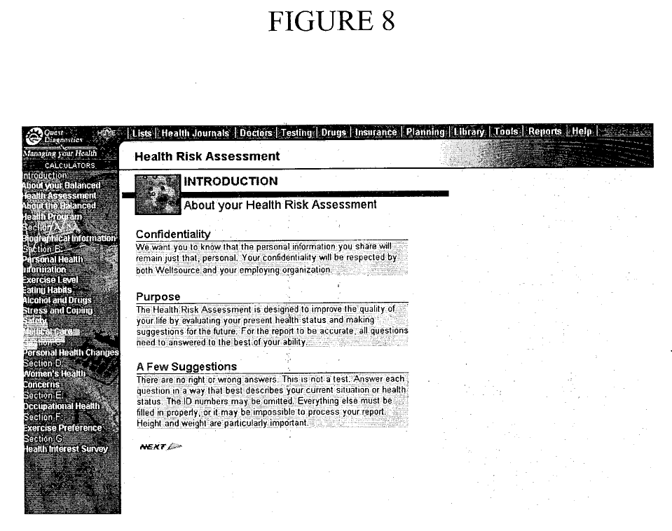

FIG. 8 provides a “Health Risk Assessment” module. The user is informed about issues of confidentiality, the purpose of risk assessment, and is provided with suggestions for its use and interpretation.

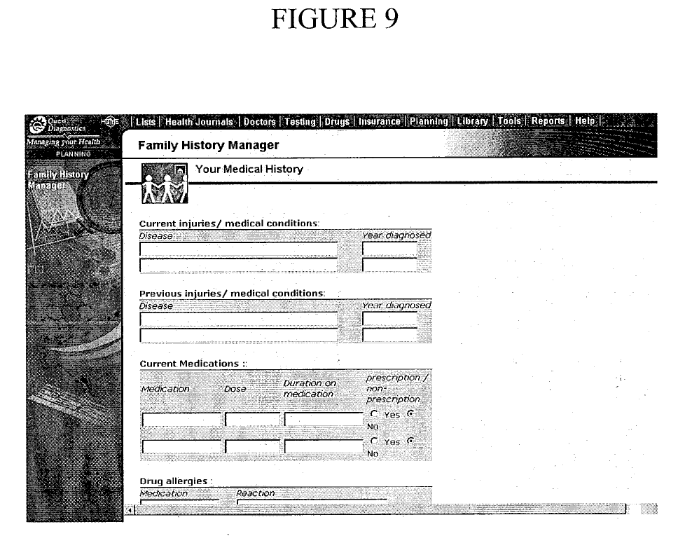

FIG. 9 shows a screen shot of a “Family History Manager” which provides details about one's medical history (i.e., “Your Medical History”) in a chart into which data is inserted by the user.

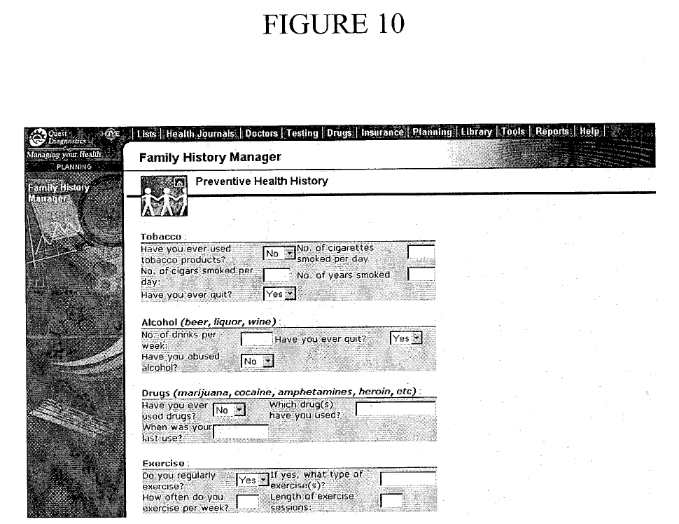

FIG. 10 provides a “Family History Manager” dedicated to Preventive Health History for an individual. The user can record activities relating to health (e.g., tobacco use, alcohol use, drug use, and exercise).

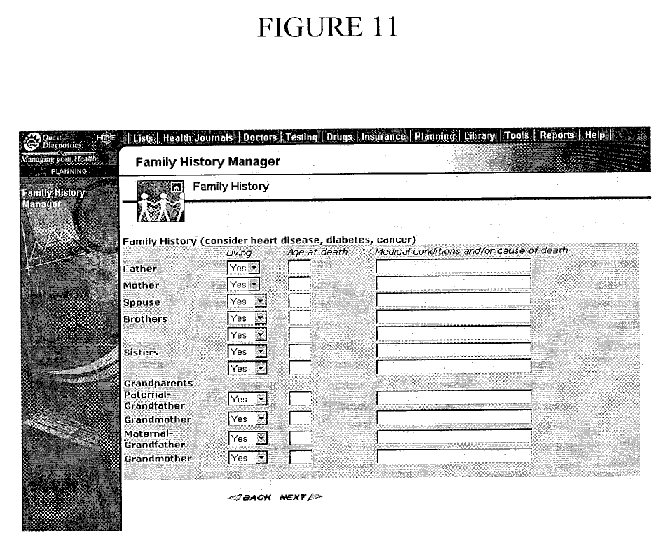

FIG. 11 shows a screen shot of a “Family History Manager” page dedicated to one's family history. Medical conditions and causes of death for various family members can be recorded for reference.

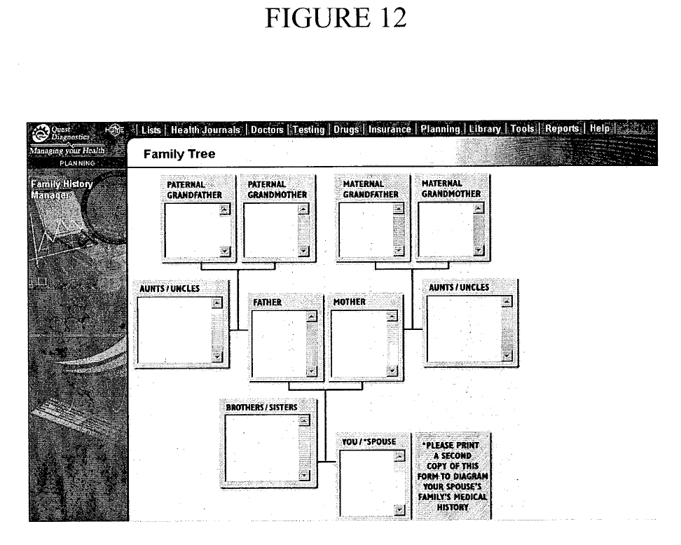

FIG. 12 shows a Family Tree page into which a user can save family tree information.

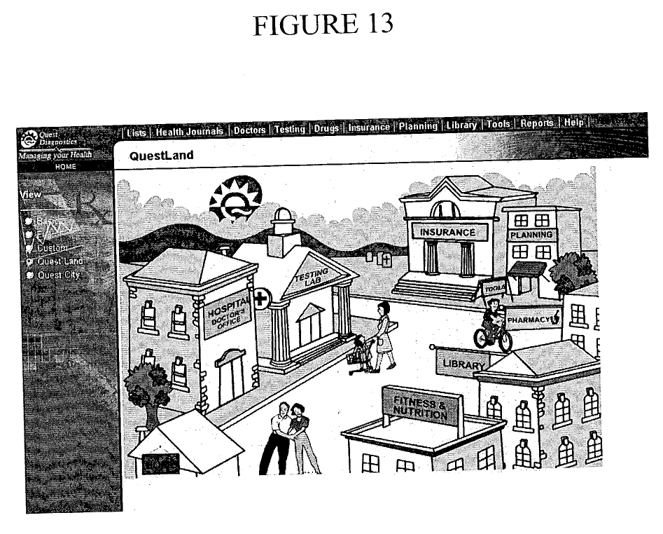

FIG. 13 provides a home page view entitled “QuestLand”, which provides a view of the interrelationship of the various aspects of health management. This screen shot also provides access for entry to various modules, including a hospital module, a testing lab module, an insurance module, a planning module, a pharmacy module, a tools module, a library module, and a fitness and nutrition module.

It will be appreciated, therefore, that an exemplary embodiment of this invention provides a software system for managing personal health related information and for developing and tracking personalized preventative care regimens. According to one preferred embodiment, the software system can be utilized on a personal computer but may also be incorporated into a web server for access by outside users on a subscription basis. Other configurations are contemplated as well.

The exemplary software system makes it possible for individuals to manage personal health related information in a private manner, wherein information heretofore not easily assembled by a user is presented in an organized, systematic fashion.

A graphical user interface (GUI) and menu driven system can be used according to exemplary aspects of this invention to allow the user to examine health related trends and data through easily understood charts and graphs, for the purposes of promoted improved health and encouraging greater participation by the user in their personal health care plan.

As illustrated in the exemplary embodiments illustrated in the figures, a main graphical interface is optionally provided for accessing separate modules of the software system. As stated previously, the modules of the exemplary embodiment include: a pharmacy module, a library module, a fitness and nutrition module, a hospital/doctor's office module, a testing lab module, a planning module, and an insurance module. By accessing one of the foregoing software modules, a corresponding GUI is presented. In this way, the system's modules provide a central management tool for use with an individual's personal health related information and preventative care programs.

According to exemplary aspects of this invention, the pharmacy module includes records of prescription data and a GUI for tracking the administration of pharmaceuticals, the frequency of use, the availability of refills, and reminders for obtaining refills. The pharmacy module also provides electronic access to medication dispensing facilities for the purposes of obtaining pharmaceuticals.

The library module optionally includes a GUI for presenting medical documentation and reference materials, such as lifestyle planning programs, exercise programs, and newsletter style information which may be provided periodically from an outside source such as a related web site.

The fitness and nutrition module, according to exemplary aspects of the invention, includes a GUI for graphically depicting dietary plans, health planning, wellness exam scheduling, exercise planning, and associated information as dictated by the user.

The hospital/doctor's office module, according to exemplary aspects of the invention, includes a GUI for tracking appointments and frequency of hospitalizations, providing reminders as to upcoming appointments, as well as indicating milestones related to the medical care of an individual.

The testing lab module, according to exemplary aspects of the invention, includes a GUI for tracking the frequency of medical testing; the results of the medical testing; and, where medical testing is conducted, test results can be retrieved from a remote location by means of the software module (i.e., via the Internet) where a predetermined vendor is utilized, thereby providing instant access to the test results.

The insurance module, according to exemplary aspects of the invention, includes a GUI for tracking financial data related to the administration of personal health insurance, including deductibles, out-of-pocket expenses, out of network providers, network providers, and may also include manuals of participating insurance providers which can be obtained through the software module at a related web site (i.e., via the Internet).

The planning module, according to exemplary aspects of the invention, includes a GUI for generating reports and graphs, diagnostic test trends, as well as preventative diagnostic templates for use in identifying health determinative factors such as the user's body weight index, cholesterol, exercise rates, calorie counters, and related indicia. For example, in use, a user may access the planning module for formulating a preventative care program.

A corresponding preventative care query template is optionally provided to the user for receiving patient specific data. The data is analyzed by the system in order to provide an indication as to a likely course of events or desired preventative maintenance path. Moreover, the graphical user interfaces (GUIs) of the software system include historical data such as graphical depictions of family personal health history for the purposes of formulating a preventative maintenance program and/or assessing one's risk for disease/sickness.

An exemplary menu structure for one embodiment of the method and system according to this invention is provided in the following list format.

Home Page

Basic tasks/Hot links

Reminders/Alerts

Diagrams indicating the relationship between the stored

information

Lists

Physicians

Patients

Categories

Journals

Contacts

Health Journals

Personal Health Journals

Doctors

Visiting your physician

How to prepare

Important information to provide

Important questions to ask

How to review/organize after the visit

Testing

Integrated with a related web site

Why get tested

Conditions to test for

Test Directory

Ordering Tests

Understanding Genetic Testing

Drugs

What you should know before starting a new drug

Warnings when starting a new drug

All about Prescription Drugs

All about Non-prescription Drugs

All about Herbs, Vitamins and alternative drugs

Insurance

Personal Insurance Journals

Information about Health Plans

Planning

Family History Manager

Wellness

Measuring

Health Risk Assessment

Preventive Testing

Monitoring

Stress Tests

Fitness

Exercise Programs

Establishing Goals

Nutrition

Managing Health Problems

Managing your Weight

Managing your Stress

Managing your Cholesterol

Managing your Sodium

Managing Life Stages

Birth-1

1-4

4-13

13-21

21-35

35-50

50-65

65-80

80+

Managing a death

Managing Life Events

Going into the Hospital

How to prepare

Important questions to ask

Know your rights

Recognizing health symptoms

Headaches

Nausea

Fever

Chills

Dizziness

Hot flashes

Managing a new illness/disease

How to find support

How to tell others about your illness

What to expect from family and friends

Specific illnesses

Heart Disease

Breast Cancer

Prostrate Cancer

Colon Cancer

Hypertension

Diabetes

General Issues

Getting married

Preparing for children

Giving birth

Traveling

Someone close to you has a new illness

Losing a spouse

Losing your job

Library

Personal Health Library

Education & Learning

Educational Courses

Educational Webcasts

Research

Search Engine (MYH and Internet)

“Top 10”

Top 100 Hospitals

Top 10 Diagnostic Tests

Top causes of disease and illness

Top 1000 Physicians

The best Health Plans

Top 10 Health Vacations

Women's Health

Men's Health

Nutrition

Alternative Medicine

Tools

Health Calculators

Cardio-Check

Thyroid-Check

Life Expectancy

Cholesterol/HDL Index

Body Mass Index

Calorie Tracker

Exercise Heart Rates

Insurance Prepayment Calculator

Health Risk Assessment

Calculator

Calendar

Export

Personal Finance

Spreadsheet

Database

Reports

Health Dashboard

Quick Reports

What appointments do I have this month (week, quarter)

What reminders do I have this month (week, quarter)

Trend Reports

Cholesterol

Weight

Glucose

Custom/Memorized

Tell me about my children

Height vs. weight chart

Vaccination Schedule

Health Risk Assessment

Physician pre-visit checklist and report

Print an Article from my PHL

Print my PHR

Medical

Lab Results

History by Physician

History by Patient

Library

List of Articles by topic

Insurance

History by Episode

Open Episodes

Reimbursements Due

Help

About Us

Contact Us

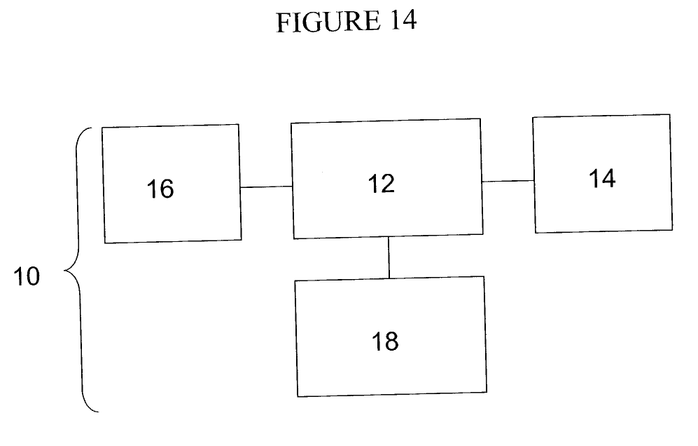

Referring to FIG. 14, a schematic diagram is provided to illustrate an exemplary embodiment of a computer system with which a health management system according to this invention can be used. The exemplary computer system 10 includes a processor 12, a memory 14 configured for the storage of information associated with the health management system, an interface 16 to facilitate a user's interface with the processor 12 (e.g., a keyboard or other known interface), and a display 18 such as a monitor or other display component for displaying information to the user of the health management system.

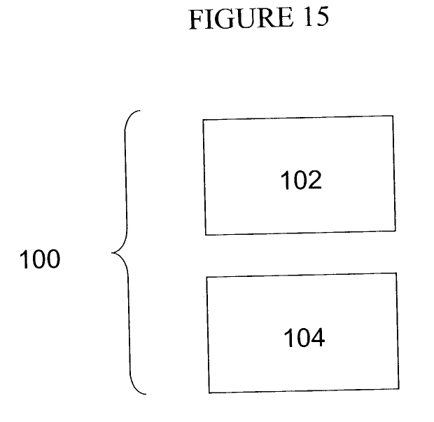

FIG. 15 provides a schematic diagram of an exemplary embodiment of a health management system 100 according to aspects of this invention. The health management system 100 includes health management modules 102 and 104. According to an exemplary embodiment of this invention, at least one of the health management modules 102 and 104 is a transaction module. Each of the health management modules 102 and 104 is configured to store information relating to personal health. The transaction module 102 or 104 is configured to receive and store health transactions of an individual or a group of individuals. An interface, such as the interface 16 illustrated in FIG. 14, is configured to provide access to one or more of the health management modules 102 and 104.

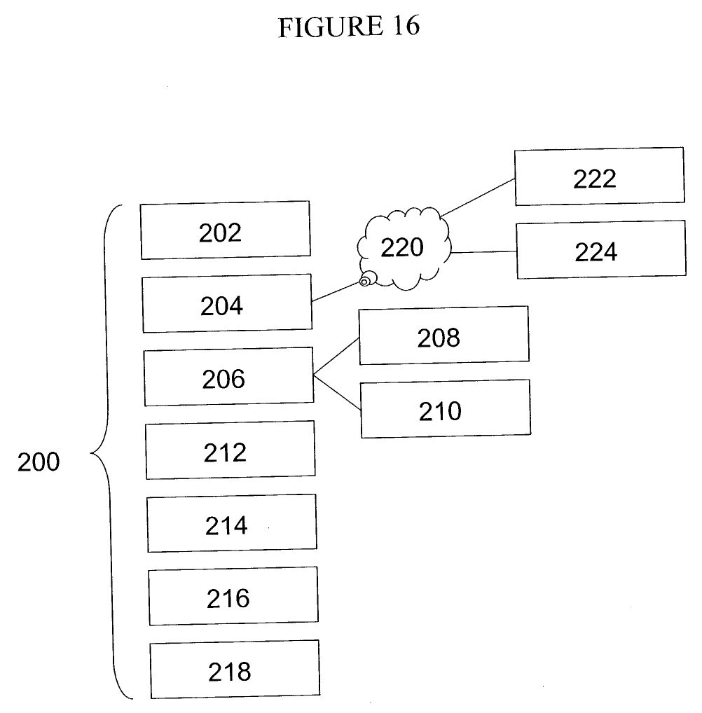

FIG. 16 is a schematic diagram illustrating another exemplary embodiment of a health management system 200 according to aspects of this invention. Health management system 200 includes a series of health management modules 202, 204, 206, 212, 214, 216, and 218, each of which is configured to store information relating to personal health. More specifically, health management system 200 includes a testing lab module 202 that is configured to receive laboratory test results. Such laboratory test results received in testing lab module 202 are optionally received from the Internet or by direct entry via an interface such as the interface 16 show in FIG. 14. Health management system 200 also includes a library module 204 that is configured to provide access to reference materials.

A planning module 206 is also provided in health management system 200. The planning module 206 is configured to provide a summary of the information relating to personal health, a summary of health transactions, and/or an action recommendation including an action schedule and/or a target result. The planning module 206 is optionally configured to display information in chart format or graph format using an interface such as the interface 16 shown in FIG. 14. Also, the planning module 206 optionally includes a health parameter calculator 206 and/or a wizard 210.

Health management system 200 also includes a pharmacy module 212 that is configured to store records of prescription data. A fitness and nutrition module 214 is also provided in health management system 200, and is configured to manage information relating to personal wellness. The health management system 200 also includes a hospital or doctor's office module 216 configured to track appointments and medical care milestones. Finally, an insurance module 218, configured to track the administration of personal health insurance, is also provided as a component of the health management system 200.

The library module 204 of the health management system 200 is optionally configured to provide access to reference materials or expert advise via the Internet 220 or a local storage device such as the memory 14 illustrated in FIG. 14. As is illustrated in FIG. 16, reference materials 222 and expert advise 224 may be accessed by the library module 204 via the Internet 220.

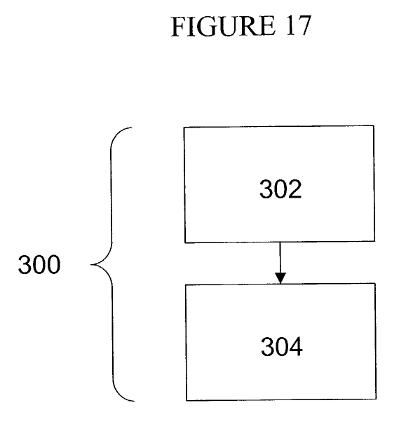

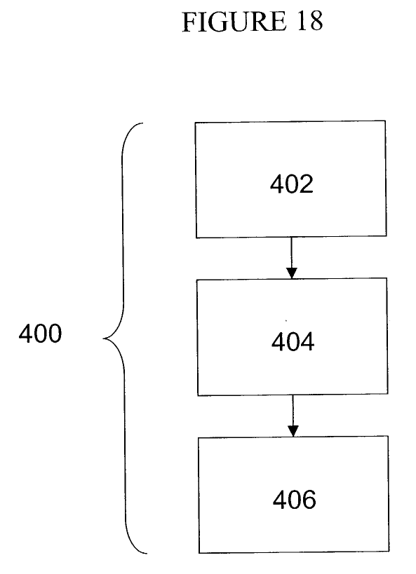

Referring now to FIGS. 17 and 18, exemplary methods according to aspects of this invention will now be described. Referring to FIG. 17, a method 300 for managing personal health is illustrated in flow diagram format. The method 300 includes a storing step 302 for storing health transactions in a transaction module of the software application, wherein the transaction module is configured to receive and store the health transactions of an individual or a group of individuals. The method 300 also includes an accessing step 304 for accessing the transaction module using an interface. The storing step 302 can include storing health transactions in a transaction module such as the testing lab module 202, pharmacy module 212, hospital or doctor office module 216, or insurance module 218, for example, of the health management system 200 illustrated in FIG. 16. The accessing step 304 optionally includes accessing the transaction module using an interface such as the interface 16 illustrated in FIG. 14.

Referring now to FIG. 18, another exemplary embodiment of a method 400 according to aspects of this invention is illustrated in flow diagram format. The method 400 is configured for providing a health management system configured for personal health management. The method 400 includes a providing step 402 for providing a software application including a plurality of health management modules. The providing step 402 includes configuring each of the health management modules to store information relating to personal health. For example, the providing step 402 optionally includes providing a software application such as the health management system 100 illustrated in FIG. 15, which includes health management modules 102 and 104. Alternatively, the providing step 402 of the method 400 can include providing a software application such as software application 200 illustrated in FIG. 16.

The method 400 also includes a configuring step 404 for configuring one or more of the health management modules to be a transaction module capable of receiving and storing health transactions of an individual or a group of individuals. For example, the configuring step 404 of the method 400 can include configuring one or more of the health management modules to be a testing lab module 202, pharmacy module 212, hospital or doctor office module 216, and/or insurance module 218 of the system 200 illustrated in FIG. 16, for example.

Finally, method 400 includes a second configuring step 406 for configuring one or more of the health management modules to be accessible using an interface. For example, configuring step 406 optionally includes configuring one or more of the health management modules to be accessible using the interface 16 of the system 10 illustrated in FIG. 14.

Although this invention has been illustrated and described with reference to selected exemplary embodiments and modifications thereof, it will be appreciated that this invention is not limited to the exemplary embodiments selected for illustration. Also, additional variations to the illustrated embodiments may be made without departing from the spirit or scope of this invention.

What is claimed:

1. A health management system configured for personal health management, said system comprising:
a software application comprising a plurality of health management modules, each of said health management modules being configured to store information relating to personal health, and one or more of said health management modules being a transaction module configured to receive and store health transactions of an individual or a group of individuals; and
an interface configured to provide access to one or more of said health management modules.

2. The health management system of claim 1 wherein at least one of said one or more transaction modules is a testing lab module configured to receive laboratory test results.

3. The health management system of claim 2 wherein said testing lab module is configured to receive laboratory test results from one or both of the Internet and direct entry via said interface.

4. The health management system of claim 1 wherein one or more of said health management modules is a library module configured to provide access to reference materials.

5. The health management system of claim 1 further comprising one or more planning modules configured to provide one or more of:
a summary of said information relating to personal health;
a summary of said health transactions; and
an action recommendation comprising one or both of an action schedule and a target result.

6. The health management system of claim 5 wherein one or more of said summary of said information, said summary of said health transactions, and said action recommendation is displayed using said interface in one or both of chart format and graph format.

7. The health management system of claim 5 comprising a plurality of planning modules.

8. The health management system of claim 5 wherein at least one of said one or more planning modules comprises one or both of a health parameter calculator and a wizard.

9. The health management system of claim 1 wherein said plurality of health management modules comprises a pharmacy module configured to store records of prescription data.

10. The health management system of claim 1 wherein said plurality of health management modules comprises a fitness and nutrition module configured to manage information relating to personal wellness.

11. The health management system of claim 1 wherein said plurality of health management modules comprises a hospital or doctor's office module configured to track appointments and medical care milestones.

12. The health management system of claim 1 wherein said plurality of health management modules comprises an insurance module configured to track the administration of personal health insurance.

13. The health management system of claim 4 wherein said library module is configured to provide access to reference materials or expert advice via the Internet or a local storage device.

14. The health management system of claim 5 wherein at least one of said planning modules is configured to access information via the Internet.

15. A method for managing personal health comprising the steps of:
storing health transactions in a transaction module of a software application, wherein the transaction module is configured to receive and store the health transactions of an individual or a group of individuals; and
accessing the transaction module using an interface.

16. The method of claim 15 wherein said transaction module is a testing lab module configured to receive laboratory test results, the method additionally comprising receiving said laboratory test results.

17. The method of claim 16 wherein said step of receiving said laboratory results comprises receiving said results from one or both of the Internet and direct entry via said interface.

18. The method of claim 15 wherein said step of accessing one or more of a plurality of health management modules comprises accessing a library module configured to provide access to reference materials.

19. The method of claim 15 further comprising accessing one or more of:
a summary of said information relating to personal health;
a summary of said health transactions; and
an action recommendation comprising one or both of an action schedule and a target result.

20. The method of claim 15 wherein said step of accessing comprises accessing a pharmacy module configured to store records of prescription data.

21. The method of claim 15 wherein said step of accessing comprises accessing a fitness and nutrition module configured to manage information relating to personal wellness.

22. The method of claim 15 wherein said step of accessing comprises accessing a hospital or doctor's office module configured to track appointments and medical care milestones.

23. The method of claim 15 wherein said step of accessing comprises accessing an insurance module configured to track the administration of personal health insurance.

24. A method of providing a health management system configured for personal health management, the method comprising the steps of:
providing a software application comprising a plurality of health management modules, said providing step comprising configuring each of said health management modules to store information relating to personal health;
configuring one or more of said health management modules to be a transaction module capable of receiving and storing health transactions of an individual or a group of individuals; and
configuring one or more of said health management modules to be accessible using an interface.

25. The method of claim 24 wherein said step of configuring one or more of said health management modules to be a transaction module comprises configuring said one or more health management modules to be a testing lab module capable of receiving laboratory test results.

26. The method of claim 25 wherein said step of configuring said one or more health management modules to be a testing lab module capable of receiving laboratory test results.

27. The method of claim 24 wherein said step of configuring each of said health management modules to store information relating to personal health comprises configuring one or more of said health management modules to be a library module capable of providing access to reference materials.

28. The method of claim 24 further comprising providing one or more planning modules configured to display one or more of:
a summary of said information relating to personal health;
a summary of said health transactions; and
an action recommendation comprising one or both of an action schedule and a target result.

29. The method of claim 24 wherein said step of configuring each of said health management modules to store information relating to personal health comprises configuring a pharmacy module to store records of prescription data.

30. The method of claim 24 wherein said step of configuring each of said health management modules to store information relating to personal health comprises configuring a fitness and nutrition module to manage information relating to personal wellness.

31. The method of claim 24 wherein said step of configuring each of said health management modules to store information relating to personal health comprises configuring a hospital or doctor's office module to track appointments and medical care milestones.

32. The method of claim 24 wherein said step of configuring each of said health management modules to store information relating to personal health comprises configuring an insurance module to track the administration of personal health insurance.
